(19) United States
(12) Patent Application Publication
(10) Pub. No.: US 2014/0145408 A1
(43) Pub. Date: May 29, 2014

(54) TRANSPORT CART

(71) Applicant: RED DEVIL EQUIPMENT CO., Plymouth, MN (US)

(72) Inventors: Thomas Midas, Oak Park Heights, MN (US); Aaron Curtis, Eagan, MN (US)

(73) Assignee: RED DEVIL EQUIPMENT CO., Plymouth, MN (US)

(21) Appl. No.: 14/086,416

(22) Filed: Nov. 21, 2013

Related U.S. Application Data
(60) Provisional application No. 61/731,167, filed on Nov. 29, 2012.

(51) Int. Cl. B62B 5/00

(52) U.S. Cl. CPC B62B 5/00
USPC 280/47.131

(57) ABSTRACT

Carts for lifting, transporting and lowering an item, such as a bucket. The carts are particularly suited for lifting, moving, and lowering 5-gallon buckets. The cart includes a lifting system that raises and lowers the item by engaging its sidewalls and any flange present on and extending out from the sidewalls. The lifting system includes an item engagement feature and a position adjustment system. The position adjustment system includes a feature that provides a displacement multiplier for lifting and lowering the engaged item.

### CROSS-REFERENCE TO RELATED APPLICATION

This application claims the benefit of U.S. Provisional Application No. 61/731,167 filed Nov. 29, 2012, the entire contents of which is incorporated herein by reference for all purposes.

### FIELD OF THE INVENTION

This application is directed to a cart, dolly or hand truck for transporting an item. More particularly, this application is directed to a cart, dolly or hand truck for transporting and lifting an item such as bucket.

### BACKGROUND

Carts, dollies and hand trucks are very useful for moving items that are heavy and/or cumbersome. However, many cart designs have a number of disadvantages. For example, for particularly heavy items, the mere action of placing the item on the support platform of the cart may be difficult. Similarly, it may be difficult to remove a particularly heavy item from the support platform after it has been moved to the desired location. Depending on the desired final location of the item, moving the item to its final location may still require manually lifting the item. This is particularly true for elevated final locations, such as on a shelf or ledge.

It would therefore be advantageous to provide a cart, dolly or hand truck that is particularly well adapted to moving items, such as containers, including lifting and lowering those items as desired.

### SUMMARY

The present invention addresses the aforementioned need by providing a cart for lifting, moving and lowering an item, such as a bucket. The hand cart of this disclosure includes an engagement mechanism configured to engage the item being lifted by its sidewalls rather than its bottom surface. The cart of this disclosure also includes a vertical position adjustment mechanism, to lift and lower the item. The vertical position adjustment mechanism has a displacement multiplier that provides an advantage when lifting and lowering the item.

One particular set of embodiments of this disclosure is to a cart that has a vertical position adjustment mechanism that includes a displacement multiplier that results in a positional advantage. For example, the disclosure provides a transport cart comprising a frame having a first wheeled end and a second end, an engagement feature moveably connected to the frame, and a position adjustment system configured to adjust the position of the engagement feature between the first end and the second end of the frame, at least a portion of the position adjustment system moveable in relation to the frame. The engagement feature is configured to engage with an outwardly extending circumferential flange on a sidewall of the item, such as a bucket. The position adjustment system comprises a cable management system having at least one wheel, and a cable connected to the cable management system at a cable first end and to the engagement feature at a cable second end. Movement of the portion of the position adjustment system moveable in relation to the frame results in movement of the engagement feature. The position adjustment system may include a displacement multiplier.

As another example, the disclosure provides a transport cart comprising a frame having a first wheeled end and a second end, an engagement feature moveably connected to the frame, the engagement feature comprising two opposing arcuate arms, and a position adjustment system, with at least a portion of the position adjustment system moveable in relation to the frame. The position adjustment system comprises a displacement multiplier and a cable connected to the displacement multiplier at a cable first end and to the engagement feature at a cable second end.

These displacement multipliers may provide a displacement advantage of at least 1:2, of at least 1:4, of at least 1:8, among others.

Another particular set of embodiments of this disclosure is to methods of moving an item, such as a bucket. For example, this disclosure provides a method of moving a bucket by bringing a wheeled cart in close proximity to the bucket, engaging an outwardly extending circumferential flange on a sidewall of the bucket with an engagement feature of the wheeled cart by raising the engagement feature, tipping the wheeled cart to elevate the bucket, transporting the elevated bucket with the cart, leveling the bucket, and lowering the engagement feature to disengage the outwardly extending circumferential flange on a sidewall of the bucket.

In another example, this disclosure provides a method of moving a bucket by bringing a wheeled cart in close proximity to the bucket, engaging an outwardly extending circumferential flange on a sidewall of the bucket with an engagement feature of the wheeled cart, tipping the wheeled cart with the engaged bucket, transporting the engaged bucket with the cart, and untipping the cart to disengage the outwardly extending circumferential flange on a sidewall of the bucket.

In any of the methods of this disclosure, the item to be picked up may be located on the same surface as the wheeled cart, on a surface even with the surface on which the wheeled cart is, or on a surface elevated in relation to the wheeled cart. Additionally or alternately, the item may be deposited on the same surface as the wheeled cart, on a surface even with the surface on which the wheeled cart is, or on a surface elevated in relation to the wheeled cart.

The above summary of the various embodiments of the disclosure is not intended to describe each illustrated embodiment or every implementation of the disclosure. These and various other features and advantages will be apparent from a reading of the following detailed description.

### BRIEF DESCRIPTION OF THE DRAWINGS

The invention may be more completely understood in consideration of the following detailed description of various embodiments of the disclosure in connection with the accompanying drawings, in which:

FIG. 1 is a front perspective view of an embodiment of a cart according to this disclosure.

FIG. 2 is a back perspective view of the cart of FIG. 1.

FIG. 3 is an enlarged perspective view of a portion of a vertical adjustment mechanism of the cart of FIGS. 1 and 2.

FIG. 4 is a front perspective view of another embodiment of a cart according to this disclosure.

FIG. 5 is a back perspective view of the cart of FIG. 4.

FIG. 6 is an enlarged perspective view of a portion of a vertical adjustment mechanism of the cart of FIGS. 4 and 5.

FIG. 7 is an enlarged perspective view of a kick plate of the cart of FIGS. 1 and 2, with the kick plate in a first position.

FIG. 8 is an enlarged perspective view of the kick plate of the cart of FIGS. 1 and 2, with the kick plate in a second position.

FIG. 9 is a side perspective view of another embodiment of a cart according to this disclosure, particularly, showing a pivoting kick plate.

FIG. 10 is a cross-sectional side view of the cart of FIG. 9, with the cart and kick plate in a first position.

FIG. 11 is a cross-sectional side view of the cart of FIG. 9, with the cart and kick plate in a second position.

FIG. 12 is a partial back perspective view of another embodiment of a cart according to this disclosure, particularly, showing an upper vertical adjustment stop in a first position.

FIG. 13 is a back perspective view of the cart of FIG. 12 with the upper vertical adjustment stop in a second position.

FIG. 14 is a partial back perspective view of another embodiment of a cart according to this disclosure, particularly, showing a hydraulic cylinder of the vertical adjustment mechanism.

FIG. 15 is a partial side perspective view of another embodiment of a cart according to this disclosure, particularly, showing an adjustable handle in a first position.

FIG. 16 is a side perspective view of the cart of FIG. 15 with the adjustable handle in a second position.

FIGS. 17 through 20 are side perspective views of the cart of FIGS. 1 and 2 lifting, transporting, and placing a bucket, as per this disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure as defined by the appended claims.

### DETAILED DESCRIPTION

The present disclosure provides carts, dollies or hand trucks for lifting, transporting and an item or container, such as a bucket. The carts of this disclosure are particularly suited for lifting, moving, and lowering 5-gallon buckets and other items having an outwardly directed circumferential flange.

It should be understood that although the description herein refers to the device as a “cart”, the device may alternately be referred to as a “dolly”, “hand truck”, “hand cart”, “mover”, “2-wheeler”, “pallet truck”, etc. It should further be understood that although the description herein refers to the item moved by the cart as a “bucket” or “5-gallon bucket”, the cart can be configured to lift, transport and lower other items.

The carts of this disclosure include a lifting system that raises and lowers the item. The lifting system includes an engagement feature and a position adjustment system. The position adjustment system includes a feature that provides a positional advantage for lifting and lowering the engaged item. The position adjustment system includes a displacement multiplier.

In the following description, reference is made to the accompanying drawing that forms a part hereof and in which are shown by way of illustration at least one specific embodiment. The following description provides additional specific embodiments. It is to be understood that still other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through the discussion provided below.

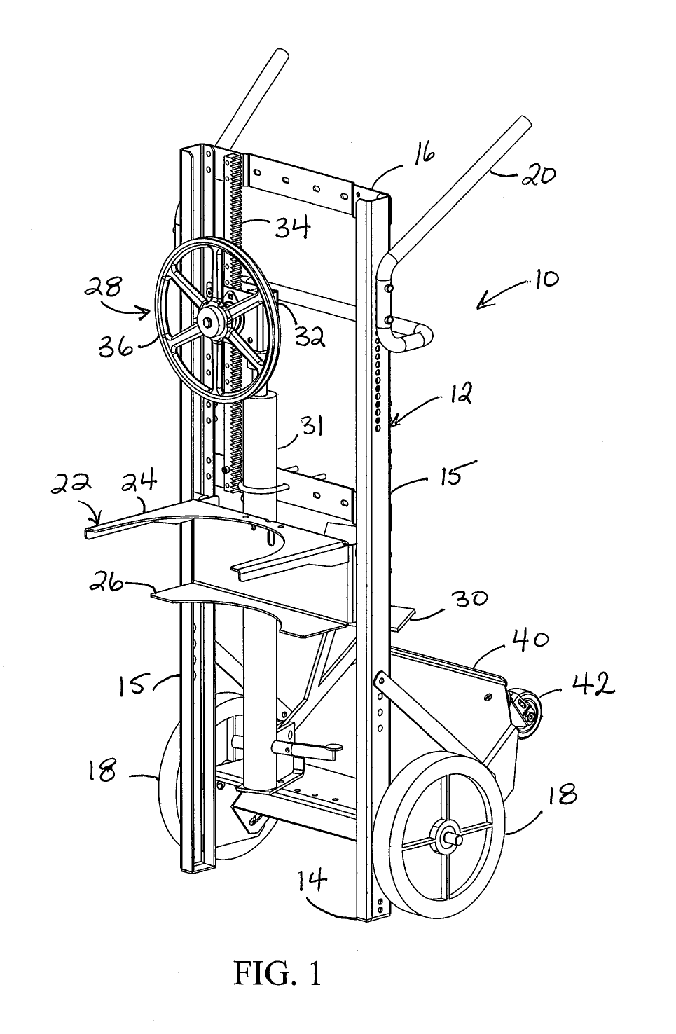

Referring now to the figures, various carts and features according to the present disclosure are illustrated in FIGS. 1 through 20. In some of these figures, a cart is illustrated retaining a bucket, such as a 5-gallon bucket; it should be understood that any of the carts illustrated or described herein can be modified to lift, hold, transport and lower other items, whether cylindrical or not.

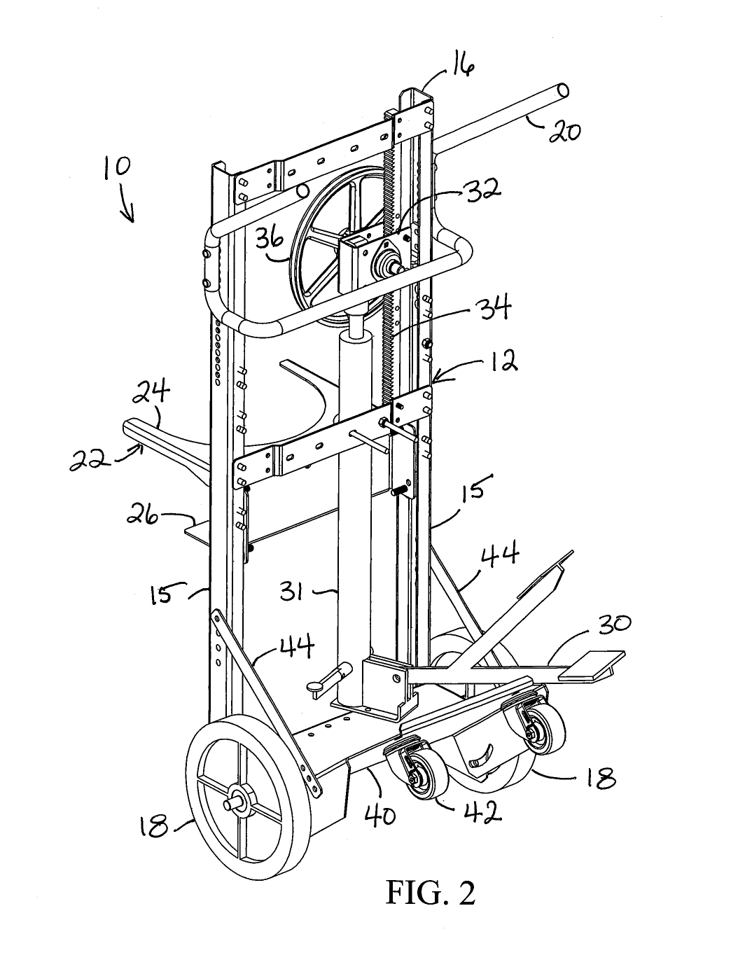

In FIGS. 1 and 2, a cart 10 is shown. Cart 10 has a structural frame 12 sufficiently strong and rigid to withstand tilting and moving of cart 10 while cart 10 is supporting and/or lifting an item. Examples of suitable materials for frame 12 include steel, iron, aluminum and other metals, reinforced plastics, and polymeric composite materials. In this embodiment, frame 12 has a generally rectangular configuration, having a first end 14, an opposite second end 16, and members 15 extending therebetween. Other configurations of frame 12 may alternately be used.

At first end 14, cart 10 includes two wheels 18 upon which cart 10 can roll. In FIGS. 1 and 2, cart 10 is positioned at rest on a surface such as a floor, in a generally vertical position, supported by first end 14 and wheels 18. At or proximate to second end 16, cart 10 includes a handle 20 to facilitate moving of cart 10 by a user. Cart 10 includes a lifting system that raises and lowers items, e.g., buckets, that are engaged by cart 10. This lifting system includes an engagement feature 22 and a position adjustment system 28.

Engagement feature 22 is configured to engage sidewalls or an element present on the sidewalls of an item (e.g., a circumferentially outwardly extending flange on a 5-gallon bucket) and support the item. In the illustrated embodiment, engagement feature 22 does not fully encircle the bucket, but encircles the bucket only so much as to sufficiently secure the bucket against cart 10 when cart 10 is tipped while allowing the bucket to be slid into and out from engagement feature 22, without the need to open clasps, straps, buckets, or the like when cart 10 is not tipped. In other embodiments, a removable or replaceable strap or other mechanism may used to better secure the bucket into engagement feature 22.

As seen in FIGS. 1 and 2, engagement feature 22 includes an upper member 24 and a lower member 26, with each member 24, 26 composed of opposite arms. At least upper member 24, and in some embodiments lower member 26, has an arcuate inner surface to better engage with the sidewall of a cylindrical item, such as a bucket. In use, when retaining a bucket, upper member 24 seats below the circumferential outwardly extending flange commonly found on 5-gallon buckets. As engagement feature 22 is raised, upper member 24 engages and provides lift to the bucket due to its contact with the bottom of the flange. Lower member 26 stabilizes the bucket, inhibiting swinging and/or swaying of the bucket.

Engagement feature 22 is moveably mounted to frame 12, moveable between first end 14 and second end 16. In one embodiment, engagement feature 22 is mounted to frame 12 via compliant guide rollers, having some amount of slack or play. Such compliant rollers may slightly pivot in relation to frame 12, facilitating correct positioning of upper member 24 of engagement feature 22 against the item to be engaged.

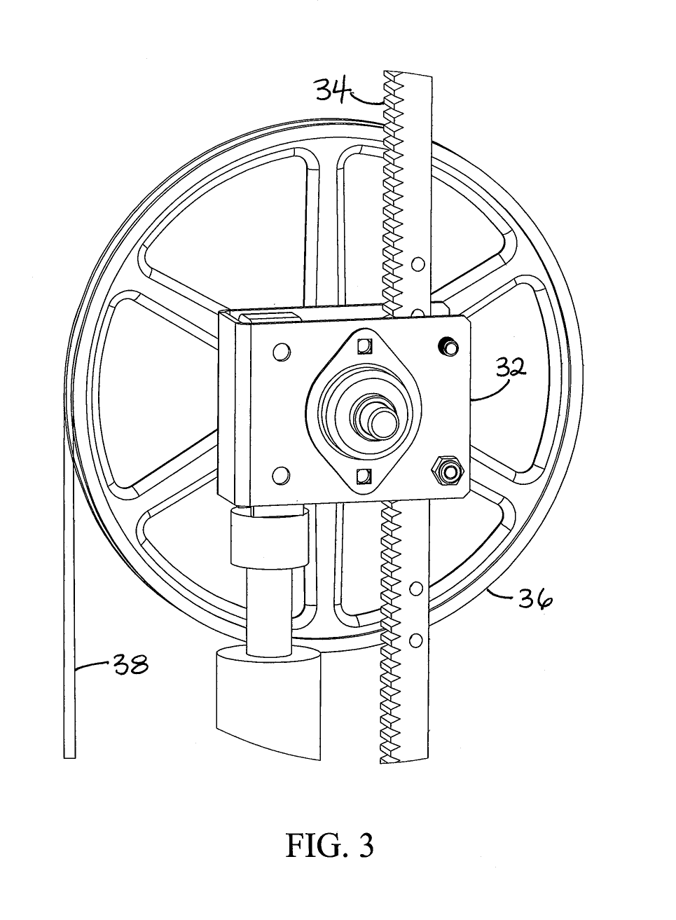

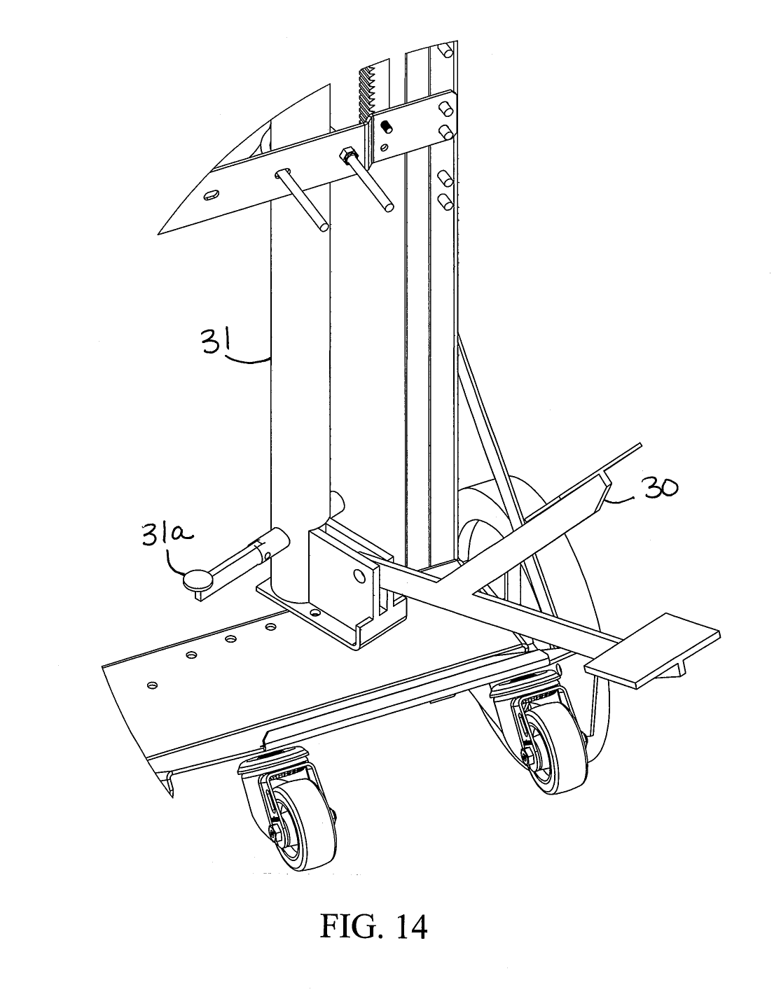

Position adjustment system 28 is operably connected to and configured to raise and lower engagement feature 22. Position adjustment system 28 has a displacement multiplier that provides a displacement advantage for raising and lowering engagement feature 22 in relation to frame 12. By use of the terms “advantage,” “displacement advantage”, and variations thereof, what is intended is, for example, vertical motion of one unit due to the direct action of the cart user will result in movement of the engagement feature of more than one unit. For cart 10 of FIGS. 1 and 2, position adjustment system 28 includes an activation lever 30 (in this embodiment a foot-activated lever) operably connected to a hydraulic cylinder 31 that in turn is connected to a pinion gear 32 which meshingly engages with gear rack 34. Activation of hydraulic cylinder 31 via lever 30 results in movement of gear 32 along rack 34. Hydraulic cylinder 31 is configured to move gear 32 toward end 16 or away from end 16; the direction of movement can be controlled by a release switch 31a on cylinder 31. FIG. 14 illustrates an embodiment of activation lever 30 and hydraulic cylinder 31; of course, hydraulic cylinders, their configurations and uses are well known, and other variations can be used. FIG. 3 illustrates an enlarged view of pinion gear 32 and gear rack 34.

Also shown in FIG. 3 is a wheel 36 fixedly connected to pinion gear 32. Preferably, the central axis of wheel 36 is aligned with the central axis of gear 32 so that wheel 36 rotates together with gear 32. Thus, as pinion gear 32 moves along rack 34, wheel 36 also rotates. Connected to the outer periphery or circumference of wheel 36 is a first end of a cable 38, the second end of which is connected to engagement feature 22. It is to be understood that a rope, wire, cord, chain, tape or other element could be used in lieu of a cable. As wheel 36 rotates one direction (in FIG. 3, clockwise), cable 38 is wound on wheel 36, and as wheel 36 rotates the other direction (in FIG. 3, counterclockwise), cable 38 is unwound from wheel 36. Wheel 36, in essence, manages the amount of available cable 38 extending to engagement feature 22.

Wheel 36 has a greater diameter (and thus circumference) than gear 32, so that in accordance with this disclosure, wheel 36 is a displacement multiplier. Because the circumference of wheel 36 is greater than the circumference of gear 32 to which it is locked, the same angle of rotation will produce a greater distance with wheel 36 than with gear 32. Thus, when hydraulic cylinder 31 via lever 30 moves gear 32 so that it travels one distance unit (e.g., inch) along rack 34, wheel 36 will move cable 38 and thus engagement feature 22 more than that one unit.

The displacement advantage provided by wheel 36 results in greater than a 1:1 movement of engagement feature 22 in relation to rack 34, in some embodiments greater than 1:2 (meaning, one distance unit of movement of gear 32 results in greater than 2 distance units of movement of engagement feature 22). In some embodiments, the ratio of movement is greater than 1:3, in other embodiments greater than 1:4, in other embodiments greater than 1:5, and in other embodiments greater than 1:6 or greater than 1:8. The displacement advantage realized is based on the relative radius of gear 32 to the radius of wheel 36; that is, the displacement advantage realized is a ratio of the radius of gear 32 to wheel 36.

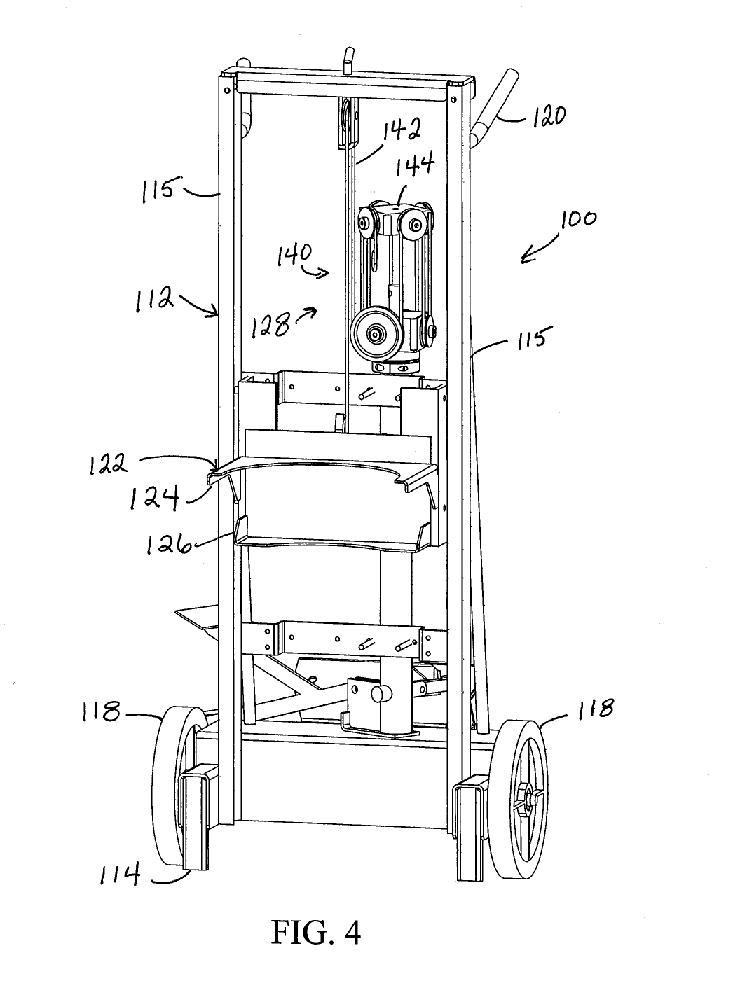

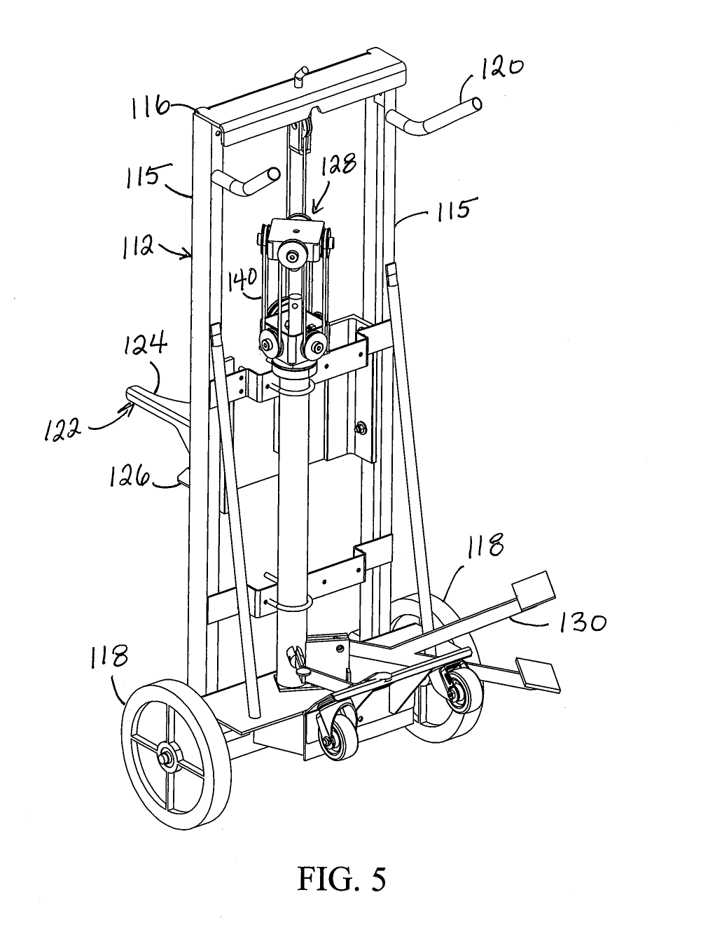

FIGS. 4 and 5 illustrate an alternate embodiment of a cart having a position adjustment system having a displacement multiplier that provides a displacement advantage. Similar to cart 10 of FIGS. 1 and 2, cart 100 of FIGS. 4 and 5 has a structure frame 112 having a first end 114, an opposite second end 116, and members 115 extending therebetween. At first end 114, cart 100 includes two wheels 118 upon which cart 100 can roll. At or proximate to second end 116, cart 100 includes a handle 120 to facilitate moving of cart 100 by a user. Similar to cart 10, cart 100 includes a lifting system that raises and lowers items that are engaged by cart 100. This lifting system includes an engagement feature 122 configured to engage a bucket (e.g., a 5-gallon bucket) and support the bucket. Engagement feature 122 includes an upper member 124 and a lower member 126.

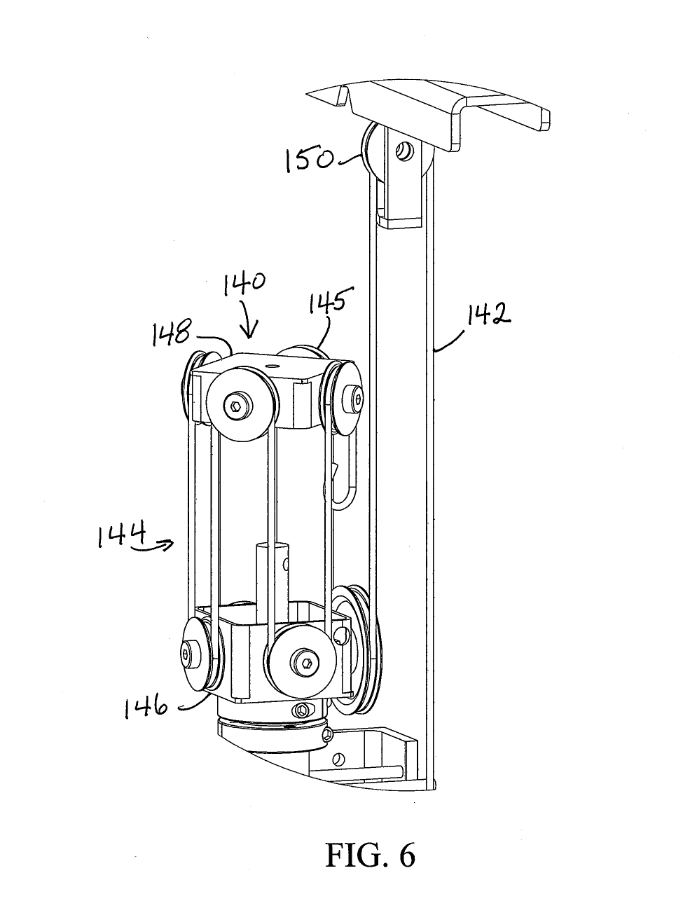

The lifting system includes a position adjustment system 128, shown in FIGS. 4 and 5 and also in FIG. 6, that includes a displacement multiplier for raising and lowering engagement feature 122. Position adjustment system 128 includes an activation lever 130 (FIG. 5) positioned close to first end 114 of cart 100 that is operably connected to engagement feature 122 via a pulley system 140, which includes a cable 142, an adjustable pulley assembly 144 including a wheel 145, and a fixed pulley 150. Adjustable pulley assembly 144 has an adjustable distance between its first end 146 and its second end 148. In this embodiment, activation lever 130 controls the distance between first end 146 and second end 148 by moving second end 148 in toward or away from first end 146. Cable 142, which winds between first end 146 and second end 148, is connected at one end to engagement feature 122 and at its other end to wheel 145 of adjustable pulley assembly 144. Pulley assembly 144 manages the available length of cable 142.

In the illustrated embodiment, position adjustment system 128 provides an 8× displacement advantage due to the eight loops of cable 142. Thus, a change in distance between first end 146 and second end 148 results in a movement 8 times as much for the opposite end of cable 142. For example, an increase of 1 inch between first end 146 and second end 148 results in engagement feature 122 being lifted 8 inches.

The illustrated pulley system 140 is a compound system with eight loops, and it should be understood that other pulley systems, providing more or less displacement advantage, could be used.

Returning to FIGS. 1 and 2, cart 10 includes, at first end 14 proximate wheels 18, a kick plate or foot rest 40 to facilitate tipping or tilting cart 10 back toward the user during movement or transport of cart 10. Positioned on the bottom side of kick plate 40 are casters 42, to facilitate stabilization of cart 10 when in the tipped position. In some embodiments, casters 42, together with wheels 18, may completely support a tipped cart 10, allowing the user to release hold of the cart.

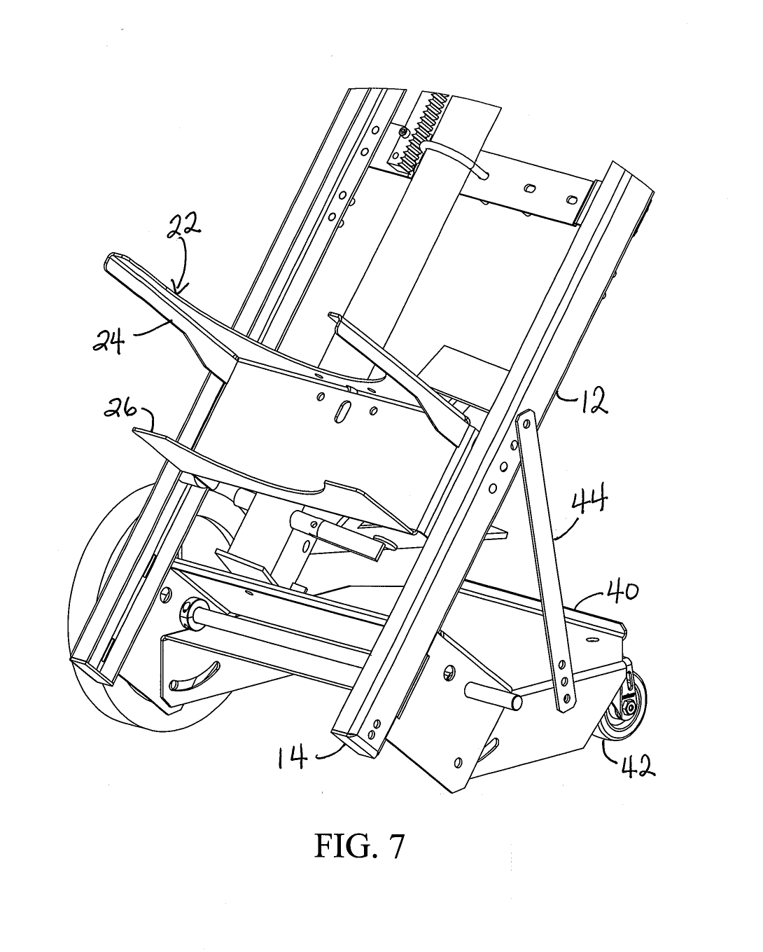

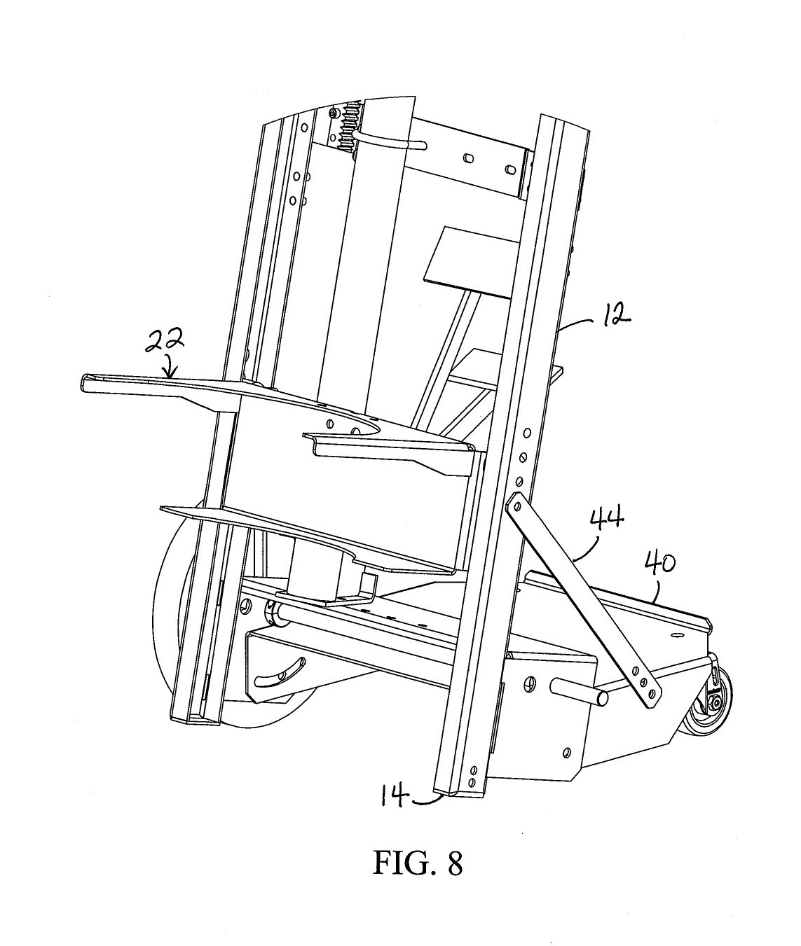

The angle of kick plate 40 in respect to frame 12, although locked during use of cart 10, can be adjustable to modify the tip of cart 10 as desired. In FIGS. 1, 2 and 7, a support member 44 connects kick plate 40 to frame 12 at an angle of about 45 degrees. This angle may be adjusted by modifying the distance between kick plate 40 and frame 12, and/or by altering the position of connection of member 44 to frame 12. In FIG. 8, the connection of support member 44 to frame 12 has been moved closer to first end 14 than in FIG. 7, resulting in a greater angle between kick plate 40 and frame 12, and thus allowing less tipping of cart 10. An angle of 30 to 60 degrees between kick plate 40 and frame 12 allows easy tipping of cart 10 and also good stability during transport.

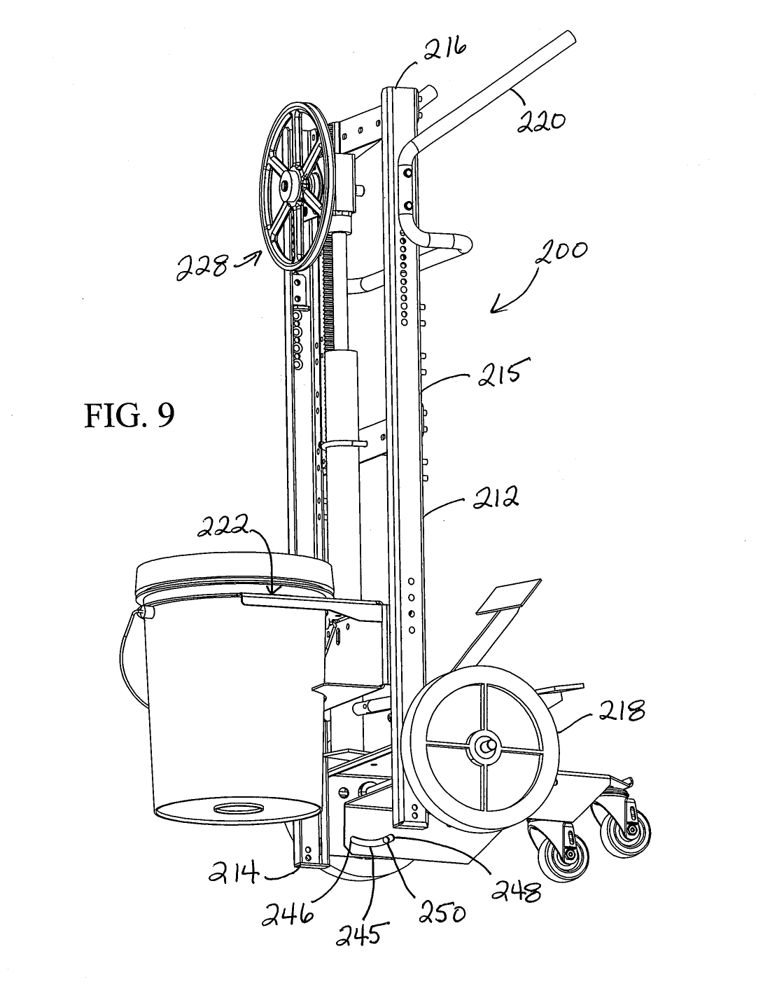

FIGS. 9 through 11 illustrate an alternate embodiment of a cart, this one having a readily pivotal kick plate. Similar to cart 10 of FIGS. 1 and 2, cart 200 of FIGS. 9 through 11 has a structural support frame 212 having a first end 214, an opposite second end 216, and members 215 extending therebetween. At first end 214, cart 200 includes two wheels 218 upon which cart 200 can roll. At or proximate to second end 216, cart 200 includes a handle. Cart 200 includes an engagement feature 222 and a position adjustment system 228.

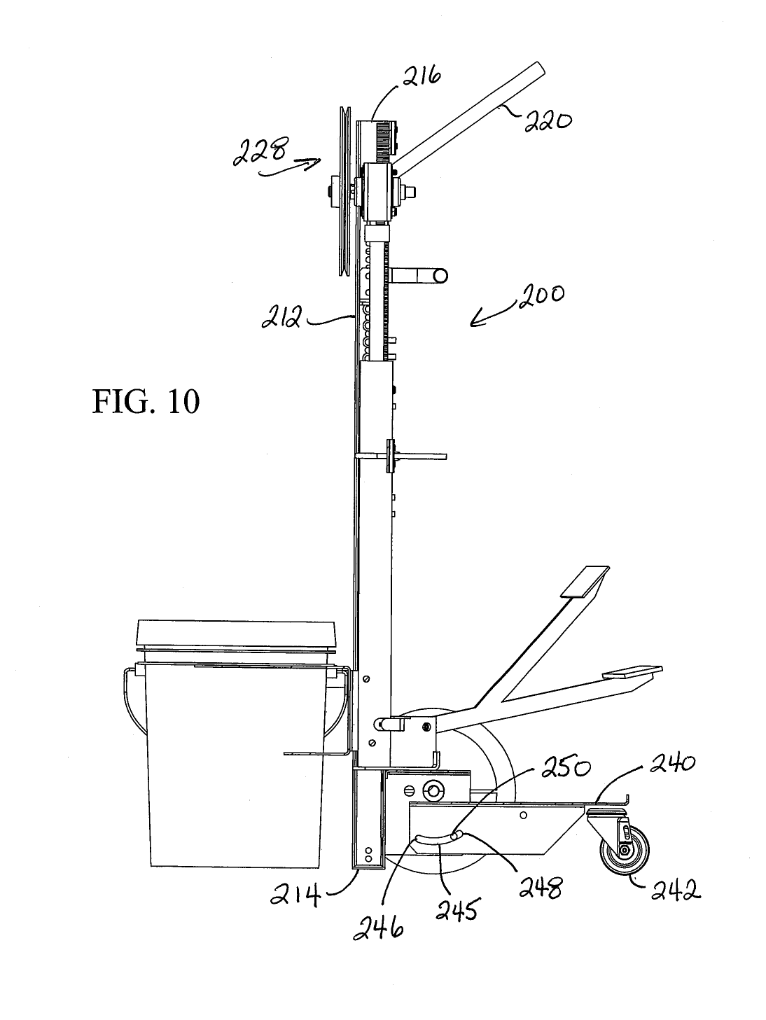

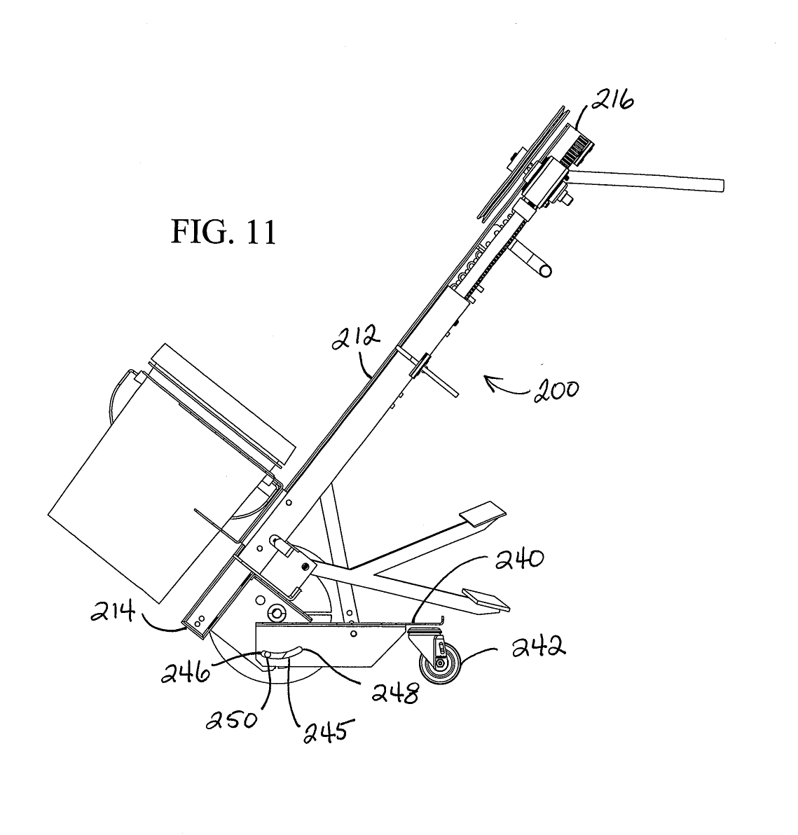

Cart 200 includes a pivotal kick plate or foot rest 240 to facilitate tipping or tilting cart 200 back toward the user during movement or transport of cart 200. Positioned on the bottom side of kick plate 240 are casters 242. Kick plate 240 includes a slot 245 therein, slot 245 having a first end 246 and an opposite second end 248. Fixedly connected to frame 212 is a pin 250 that fits within slot 245. As pin 250 moves in slot 245, the angle between kick plate 240 and frame 212 changes, thus modifying the angle of possible tipping of cart 200. In FIGS. 9 and 10, pin 250 is positioned proximate second end 248 of slot 245, providing an angle of essentially 90 degrees between kick plate 240 and frame 212. In FIG. 11, pin 250 is positioned proximate first end 246 of slot 245, providing an angle of about 45 degrees between kick plate 240 and frame 212. By having a kick plate 240 that is readily pivotally adjustable, all four wheels (i.e., wheels 218 and casters 242) may remain in contact with the ground as cart 200 is pivoted forward.

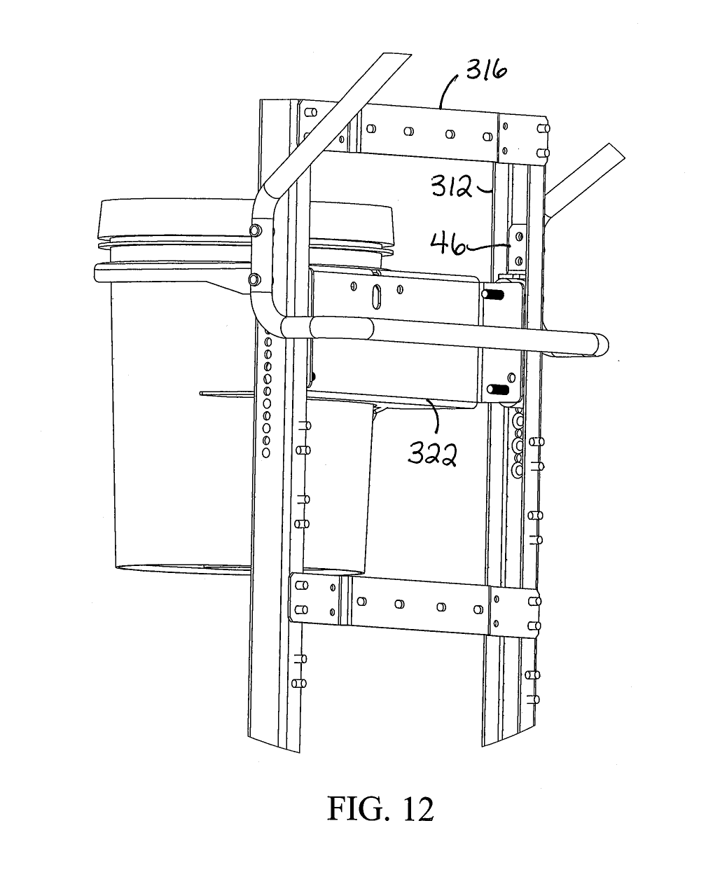

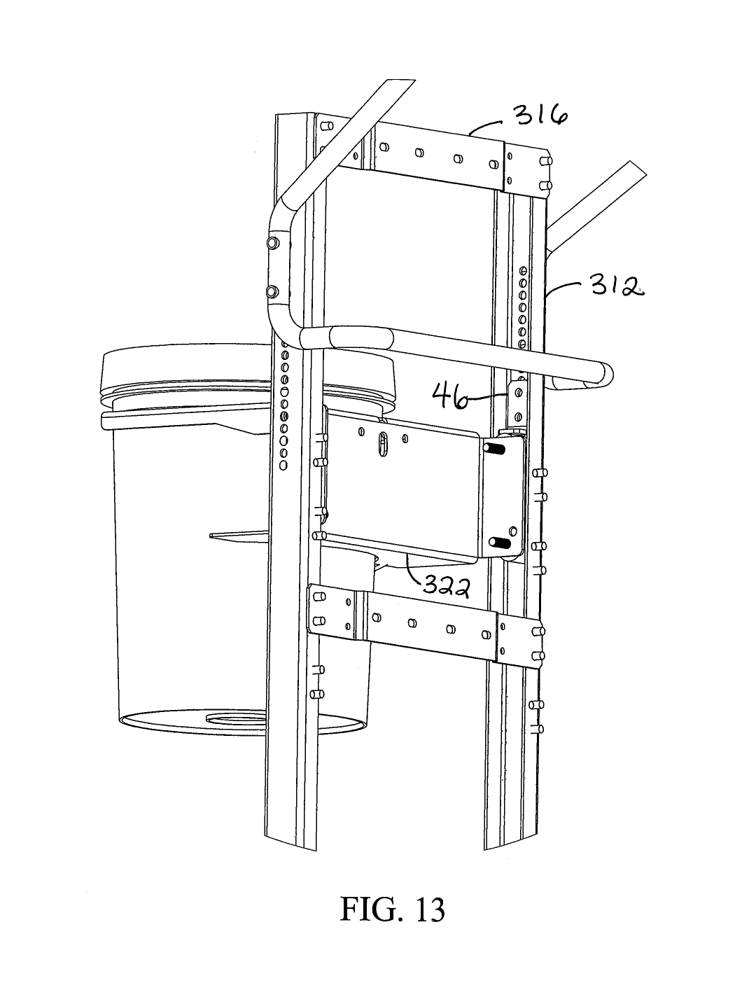

The carts of this disclosure (e.g., cart 10, cart 100, cart 200) may include any number of various features to limit the movement of the item or bucket engagement feature (e.g., feature 22, 122, 222) along the cart frame (e.g., frame 12, 112, 212). Referring to FIG. 12, a stop 46 on frame 312 is illustrated, limiting further movement of bucket engagement feature 322 toward end 316 of the cart. The position of stop 46 may be adjustable; see FIG. 13, where stop 46 is illustrated in a different position. In some embodiments, it may be desirable to position stop 46 at a height corresponding to a specific unloading height. In addition, the carts of this disclosure may include a lower stop to limit movement of the engagement feature toward the wheeled end of the cart.

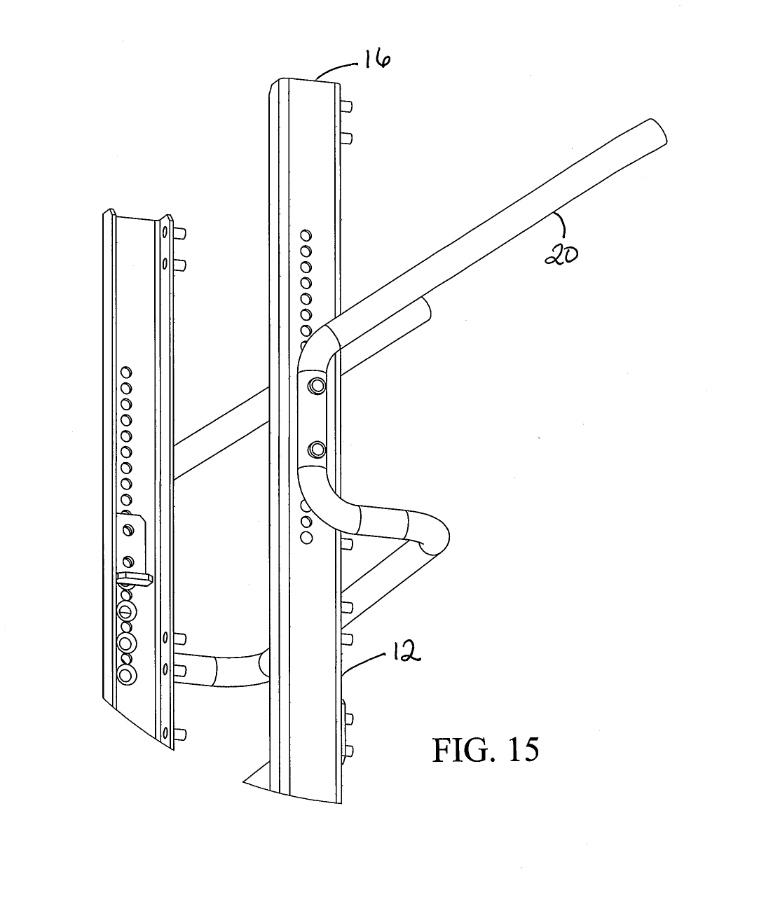

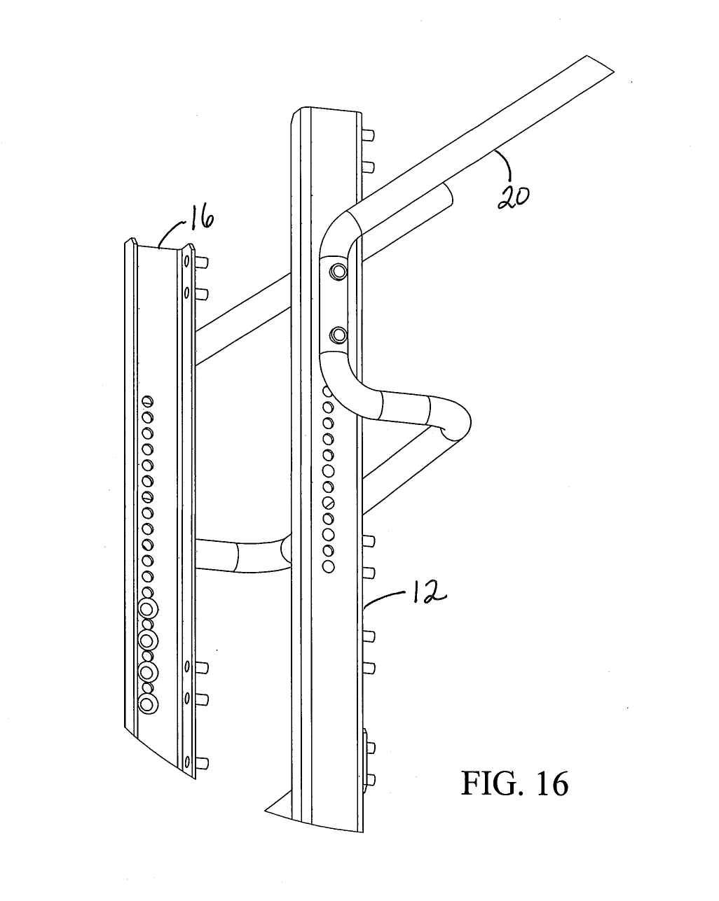

Returning to FIGS. 1 and 2, as indicated, cart 10 includes a handle 20 at or close to second end 16. Handle 20 includes a horizontal member (extending between frame members 15) and terminal handle ends. Cart 100 of FIG. 5 has an alternate handle 120, having no horizontal member but two handle ends. Handle 20, and other handles, may be adjustable in respect to frame 12. In FIG. 15, handle 20 is positioned on frame 12 farther from end 16 than in FIG. 16, where handle 20 is closer to end 16.

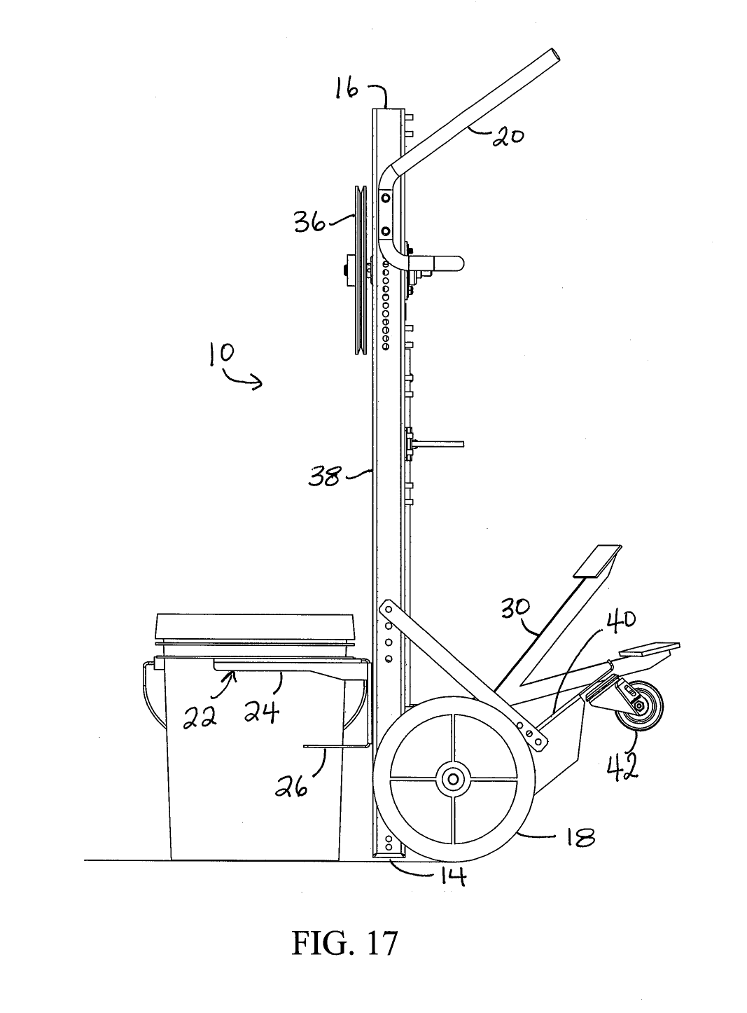

As indicated above, the various carts of this disclosure can be used to lift, transport, and lower items, particularly buckets. FIGS. 17 through 20 illustrate such an activity with cart 10, described above.

First, as illustrated in FIG. 17, cart 10 is moved into position so that engagement mechanism 22 engages a bucket. Engagement mechanism 22 may require movement upwards (i.e., toward end 16) or downward (i.e., toward end 14) so that upper member 24 is positioned under and in contact with an outwardly extending flange or ridge on the bucket, and lower member 26 is positioned preferably against the sidewalls of the bucket. At this step, cart 10 is resting on wheels 18 optionally balanced by the engaged bucket.

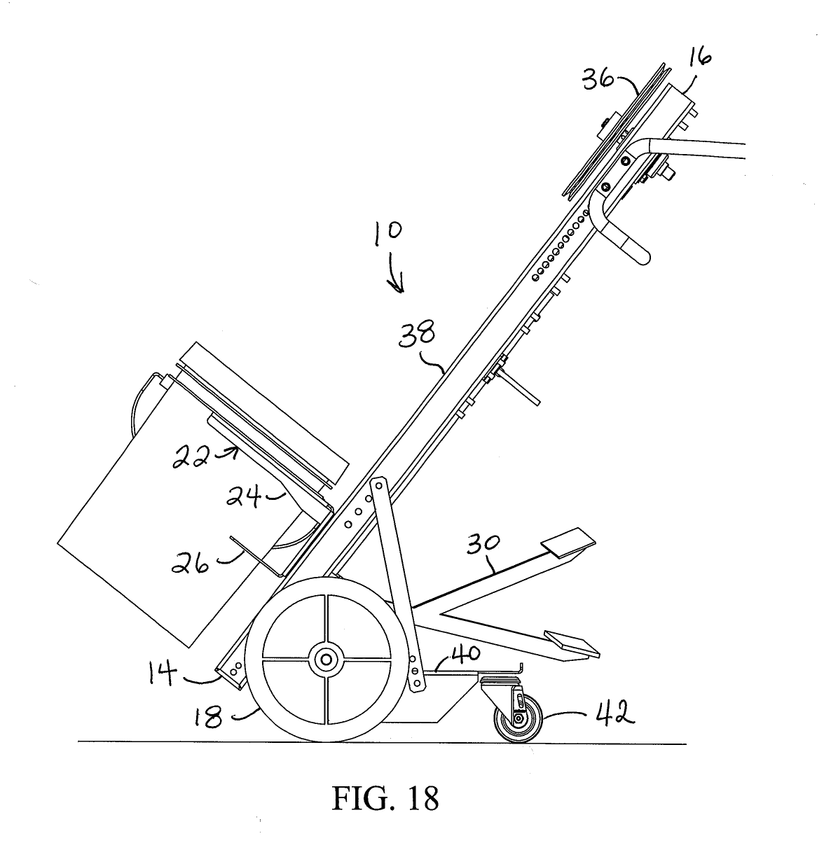

In FIG. 18, cart 10 is shown tipped back on casters 42. This may be accomplished by the user, who would be standing to the right of cart 10 in the figures, placing a foot on kick plate 40 while holding handle 20 and tipping cart 10 back toward himself. At this step, cart 10 is resting on wheels 18 and casters 42, with the bucket lifted off the ground by the engagement of upper member 24 against the bottom of the outwardly extending flange or ridge on the bucket. In this manner, cart 10 can readily and easily move the bucket to a desired location.

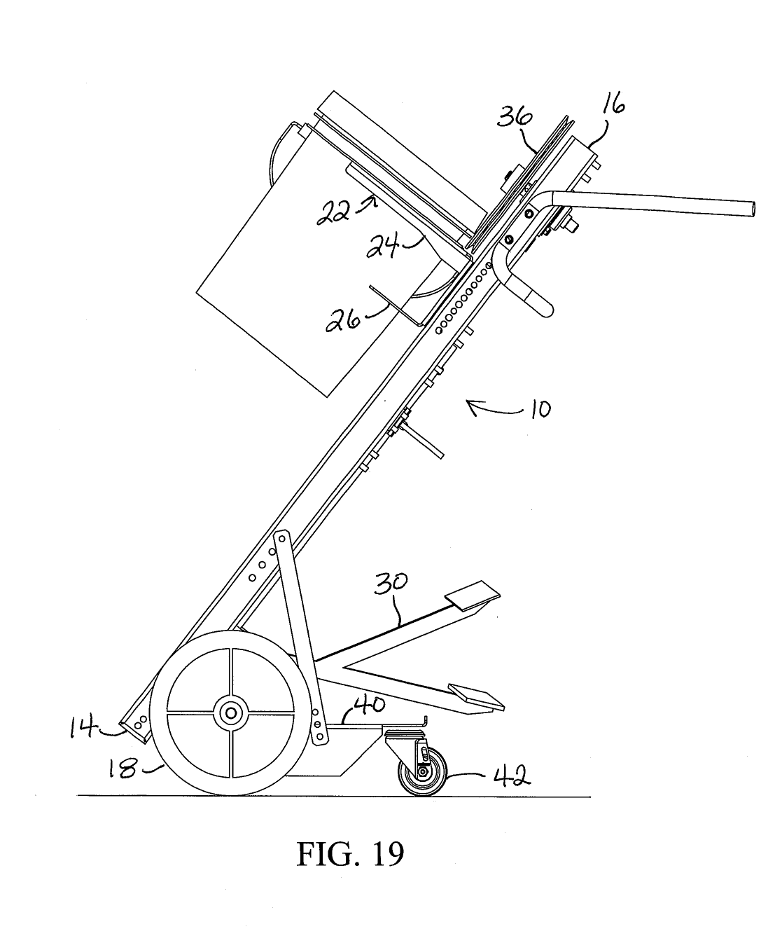

In FIG. 19, the bucket is shown lifted to an elevated position on cart 10 via the position adjustment system which includes lever 30, wheel 36 and cable 38. To move the bucket from the position of FIG. 18 to that of FIG. 19, the user activates (e.g., pumps) lever 30, thus rotating the pinion gear and wheel 36. Rotation of wheel 36 pulls cable 38 and thus engagement mechanism 22 toward end 16. Because of the displacement advantage provided by wheel 36 (due to wheel 36 having a larger radius than the pinion gear), engagement mechanism 22 and the bucket move quicker toward end 16 than the pinion gear. By having the bucket in an elevated position, it can be easily placed in a raised location, such as a bench or shelf without requiring lifting by the user.

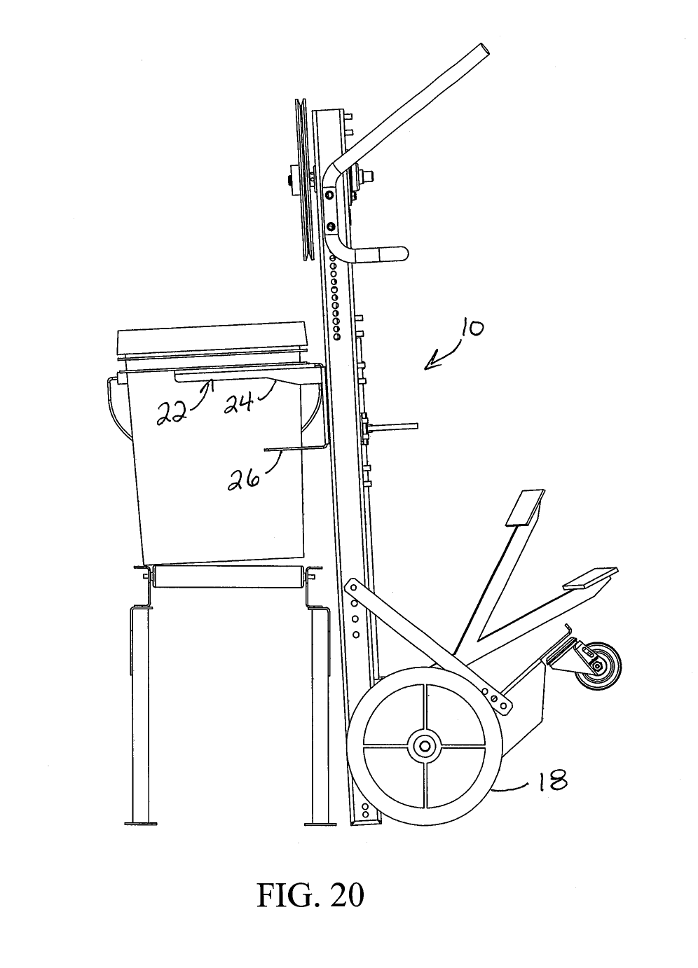

In FIG. 20, the bucket is shown deposited on a roller conveyor by cart 10. This is accomplished by moving cart 10 with the bucket to the desired location, tipping cart 10 back to an essentially upright position, and lowering the bucket via the position adjustment system. The tipping and lowering may be done in either order or simultaneously. After the bucket has been placed at the desired location, engagement mechanism 22 is sufficiently lowered to disengage upper member 24 from the outwardly extending flange or ridge on the bucket, and cart 10 can be removed.

In another alternate method, the bucket may be lifted (in a manner similar to illustrated in FIG. 17) but from a location that is elevated in relation to the location of the cart. That is, carts of this disclosure can be used to pick up buckets and other items that are at an elevated location, such as on a shelf, pallet, conveyor system, on another similar item, etc.

In some methods, it may not be necessary to activate the position adjustment system of the cart. Merely tipping the cart back may be sufficient to raise the bucket sufficiently so that it can be moved. Similarly, merely tipping the cart forward may be sufficient to release and deposit the bucket in the desired location.

Thus, various embodiments of the TRANSPORT CART are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

1. A transport cart comprising:
a frame having a first wheeled end and a second end;
an item engagement feature moveably connected to the frame, the engagement feature configured to engage with an outwardly extending circumferential flange on a sidewall of an item;
a position adjustment system configured to adjust the position of the engagement feature between the first end and the second end of the frame, the position adjustment system comprising:
a cable management system comprising at least one wheel; and
a cable connected to the cable management system at a cable first end and to the engagement feature at a cable second end.

2. The cart of claim 1, wherein the position adjustment system comprises a gear rack fixedly attached to the frame and a pinion gear movable in relation to the gear rack, with the at least one wheel of the cable management system fixedly connected to the pinion gear.

3. The cart of claim 2, wherein the position adjustment system further comprises a hydraulic cylinder connected to the pinion gear, configured to move the pinion gear in meshing engagement with the gear rack.

4. The cart of claim 3, wherein the position adjustment system further comprises a foot lever to control the hydraulic cylinder

5. The cart of claim 1, wherein the position adjustment system comprises a pulley assembly having a first end and a second end moveable in relation to the first end, with the cable extending between the first end and the second end.

6. The cart of claim 5, wherein the position adjustment system further comprises a hydraulic cylinder connected to the second end of the pulley assembly, configured to move the second end in relation to the first end.

7. The cart of claim 6, wherein the position adjustment system further comprises a foot lever to control the hydraulic cylinder

8. The cart of claim 1, wherein the engagement feature comprises an arcuate member having two opposing arms.

9. The cart of claim 1, further comprising a kick plate proximate the first wheeled end of the frame.

10. The cart of claim 9 further comprising a caster on a bottom of the kick plate.

11. The cart of claim 1, wherein the engagement feature is moveably connected to the frame via rollers.

12. The cart of claim 1, wherein the position adjustment system comprises a displacement multiplier.

13. The cart of claim 12, wherein the displacement multiplier produces a displacement advantage of at least 1:4.

14. A method of moving a bucket, the method comprising:
bringing a wheeled cart in close proximity to the bucket;
engaging an outwardly extending circumferential flange on a sidewall of the bucket with an engagement feature of the wheeled cart by raising the engagement feature;
tipping the wheeled cart to elevate the bucket;
transporting the elevated bucket with the cart;
leveling the bucket; and lowering the engagement feature to disengage the outwardly extending circumferential flange on a sidewall of the bucket.

15. The method of claim 14 further comprising:
further raising the engagement feature after engaging the outwardly extending circumferential flange on a sidewall of the bucket.

16. The method of claim 15 comprising:
completely lowering the engagement feature to disengage the outwardly extending circumferential flange on a sidewall of the bucket.

17. The method of claim 15 comprising:
partially lowering the engagement feature to disengage the outwardly extending circumferential flange on a sidewall of the bucket.

18. The method of claim 14 wherein raising the engagement feature and lowering the engagement feature comprises utilizing a displacement multiplier.

19. A method of moving a bucket, the method comprising:
bringing a wheeled cart in close proximity to the bucket;
engaging an outwardly extending circumferential flange on a sidewall of the bucket with an engagement feature of the wheeled cart;
tipping the wheeled cart with the engaged bucket;
transporting the engaged bucket with the cart; and
untipping the cart to disengage the outwardly extending circumferential flange on a sidewall of the bucket.

20. The method of claim 19, wherein when engaging the bucket, the bucket is located on the same surface as the wheeled cart.

21. The method of claim 19, wherein when engaging the bucket, the bucket is located on a surfaced elevated in relation to the wheeled cart.

22. The method of claim 19, wherein the step of tipping the wheeled cart engages the outwardly extending circumferential flange of the bucket with the engagement feature of the wheeled cart.

23. The method of claim 19, wherein when disengaging the bucket, the bucket is resultingly located on a surfaced elevated in relation to the wheeled cart.
